(19) United States
(12) Patent Application Publication
(10) Pub. No.: US 2019/0170599 A1
(43) Pub. Date: Jun. 6, 2019

(54) SYSTEMS AND METHODS FOR LEAK MANAGEMENT UTILIZING SUB-BAROMETRIC REFRIGERANT CONDUIT SLEEVES

(71) Applicant: Johnson Controls Technology Company, Auburn Hills, MI (US)

(72) Inventor: Douglas A. Kester, York, PA (US)

(21) Appl. No.: 15/871,702

(22) Filed: Jan. 15, 2018

Related U.S. Application Data
(60) Provisional application No. 62/593,557, filed on Dec. 1, 2017.

(51) Int. Cl. G01M 3/16; F25B 49/00; G01M 3/24

(52) U.S. Cl. CPC G01M 3/16; F25B 2500/222; G01M 3/24; F25B 49/005

(57) ABSTRACT

A refrigerant leak management system includes a sleeve member having an inner surface, the sleeve member configured to be disposed over an outer surface of a length of a refrigerant conduit such that a gap is defined between the inner surface of the sleeve member and the outer surface of the refrigerant conduit. The refrigerant leak management system also includes a fluid moving device configured to fluidly couple to the gap and configured to maintain a sub-barometric pressure within the gap, and a sensor fluidly coupled to the gap and configured to detect a concentration of a leaked refrigerant in the gap.

### CROSS-REFERENCE TO RELATED APPLICATION

This application is a Non-Provisional application claiming priority to U.S. Provisional Application No. 62/593,557, entitled “SYSTEMS AND METHODS FOR LEAK MANAGEMENT UTILIZING SUB-BAROMETRIC REFRIGERANT CONDUIT SLEEVES,” filed Dec. 1, 2017, which is hereby incorporated by reference in its entirety for all purposes.

### BACKGROUND

The present disclosure relates generally to heating, ventilating, and air conditioning (HVAC) systems, and more particularly to refrigerant leak management for HVAC systems.

Residential, light commercial, commercial, and industrial HVAC systems are used to control temperatures and air quality in residences and buildings. Generally, the HVAC systems may circulate a refrigerant through a closed refrigeration circuit between an evaporator, where the refrigerant absorbs heat, and a condenser, where the refrigerant releases heat. The refrigerant flowing within the circuit is generally formulated to undergo phase changes within the normal operating temperatures and pressures of the system so that quantities of heat can be exchanged by virtue of the latent heat of vaporization of the refrigerant. As such, the refrigerant flowing within a HVAC system travels through multiple conduits and components of the circuit. Inasmuch as refrigerant leaks compromise system performance or result in increased costs, it is accordingly desirable to provide detection and response systems and methods for the HVAC system to reliably detect and respond to any refrigerant leaks of the HVAC system.

### SUMMARY

In one embodiment of the present disclosure, a refrigerant leak management system for a heating, ventilation, and air conditioning (HVAC) system includes a sleeve member having an inner surface, the sleeve member configured to be disposed over an outer surface of a length of a refrigerant conduit of the HVAC system such that a gap is defined between the inner surface of the sleeve member and the outer surface of the refrigerant conduit. The refrigerant leak management system also includes a fluid moving device configured to fluidly couple to the gap and configured to maintain a sub-barometric pressure within the gap. Additionally, the refrigerant leak management system includes a sensor fluidly coupled to the gap and configured to detect a concentration of a leaked refrigerant in the gap.

In another embodiment of the present disclosure, a heating, ventilation, and air conditioning (HVAC) system includes a refrigerant conduit of a refrigeration circuit and a sleeve member configured to be disposed circumferentially around a length of the refrigerant conduit having an outer surface. A gap is defined between an inner surface of the sleeve member and the outer surface of the refrigerant conduit. The refrigerant sleeve system also includes a fluid moving device fluidly coupled to the gap and configured to maintain a sub-barometric pressure within the gap. Additionally, the refrigerant leak management system includes a sensor fluidly coupled to the gap and configured to detect a concentration of a leaked refrigerant in the gap.

In a further embodiment of the present disclosure, a method of operating a refrigerant leak management system of a heating, ventilation, and air conditioning (HVAC) system of a building includes operating, via a HVAC controller, a fluid moving device to maintain a sub-barometric pressure within a gap defined between an inner surface of a sleeve member and an outer surface of a refrigerant conduit of the HVAC system. The sleeve member circumferentially surrounds a length of the refrigerant conduit of the HVAC system. The method includes determining, via the HVAC controller, a concentration of a leaked refrigerant within the gap based on input from a sensor. Additionally, the method includes modifying, via the HVAC controller, operation of the HVAC system in response to determining that the concentration of the leaked refrigerant is greater than a predefined concentration threshold.

Other features and advantages of the present application will be apparent from the following, more detailed description of the embodiments, taken in conjunction with the accompanying drawings which illustrate, by way of example, the principles of the application.

### BRIEF DESCRIPTION OF THE DRAWINGS

FIG. 1 is an illustration of an embodiment of a commercial or industrial HVAC system, in accordance with present techniques;

FIG. 2 is an illustration of an embodiment of a packaged unit of the HVAC system, in accordance with present techniques;

FIG. 3 is an illustration of an embodiment of a split system of the HVAC system, in accordance with present techniques;

FIG. 4 is a schematic diagram of an embodiment of a refrigeration system of the HVAC system, in accordance with present techniques;

FIG. 5 is a schematic diagram of an embodiment of a refrigerant leak management system of the HVAC system, in accordance with present techniques;

FIG. 6 is a front perspective view of an embodiment of a refrigerant conduit sleeve of the refrigerant leak management system of FIG. 5, in accordance with present techniques;

FIG. 7 is a side cross-sectional view of an embodiment of the refrigerant conduit sleeve of FIG. 6 taken along line 7-7, in accordance with present techniques;

FIG. 8 is a cross-sectional view of an embodiment of the refrigerant conduit sleeve of FIG. 7 taken along line 8-8, in accordance with present techniques;

FIG. 9 is a cross-sectional view of an embodiment of the refrigerant conduit sleeve of FIG. 7 taken along line 8-8, in accordance with present techniques;

FIG. 10 is a cross-sectional view of an embodiment of the refrigerant conduit sleeve of FIG. 7 taken along line 8-8, in accordance with present techniques;

FIG. 11 is a cross-sectional view of an embodiment of the refrigerant conduit sleeve of FIG. 7 taken along line 8-8, in accordance with present techniques; and

FIG. 12 is a flow diagram representing an embodiment of a process of operating the refrigerant leak management system of FIG. 5, in accordance with present techniques.

### DETAILED DESCRIPTION

As discussed above, a HVAC system generally includes a refrigerant flowing within a refrigeration circuit. However, the refrigerant may inadvertently leak from a flow path of the refrigeration circuit due to wear or damage to components, or faulty joints or connections within the refrigeration circuit at some point after installation. If undetected, leaking refrigerant may compromise system performance or result in increased costs. As such, present techniques enable HVAC systems to reliably detect and manage refrigerant leaks.

With the foregoing in mind, present embodiments are directed to a refrigerant leak management system that is capable of detecting and/or mitigating refrigerant leaking from a refrigeration circuit of a HVAC system. The disclosed refrigerant leak management system includes at least one refrigerant conduit sleeve positioned around at least one refrigerant conduit of the refrigeration circuit of the HVAC system. A gap or space is defined between an interior surface or boundary of the sleeve and an exterior surface or boundary of the refrigerant conduit. A fan or other suitable fluid moving device is fluidly coupled to, and maintains a sub-barometric pressure within, this gap. The fan generally draws air from the gap of the sleeve near a refrigerant gas concentration sensor, or other suitable detection mechanism, before driving the air into an environment outside of the sleeve. A controller is communicatively coupled to the refrigerant gas concentration sensor and generally determines whether a refrigerant leak is present in the HVAC system based on measurement data received from the refrigerant gas concentration sensor. Additionally, the controller may instruct portions of the refrigerant leak management system and/or the HVAC system to take corrective action to mitigate the refrigerant leak. For example, in response to a refrigerant leak, the controller may increase air flow through the sleeve to drive leaked refrigerant from the gap. In this manner, the disclosed techniques enable detection of refrigerant leak within the HVAC system, and enable response via any combination of suitable control actions to address the leaked refrigerant.

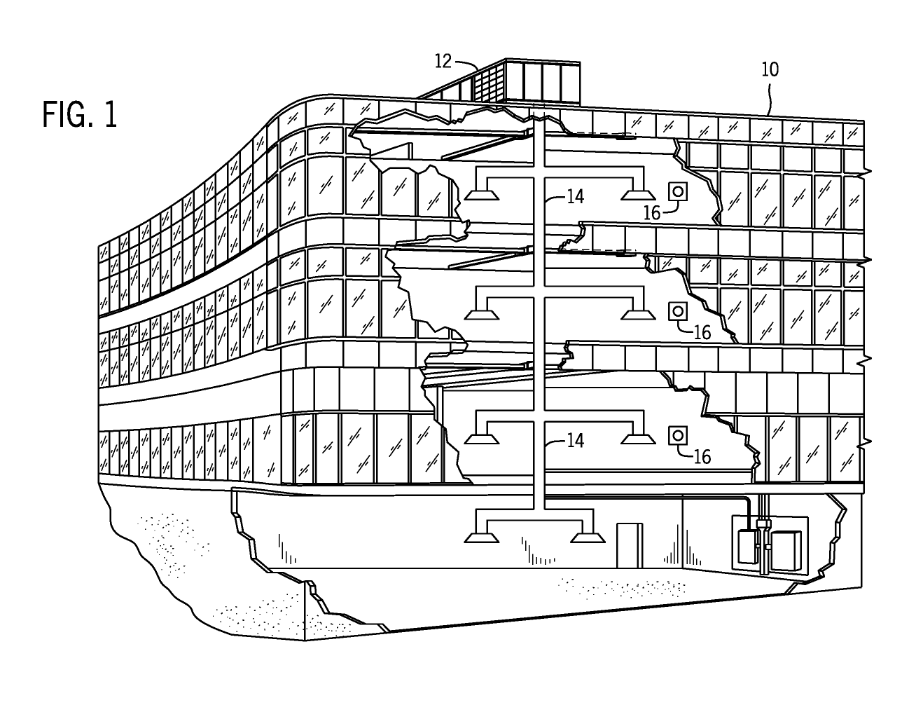

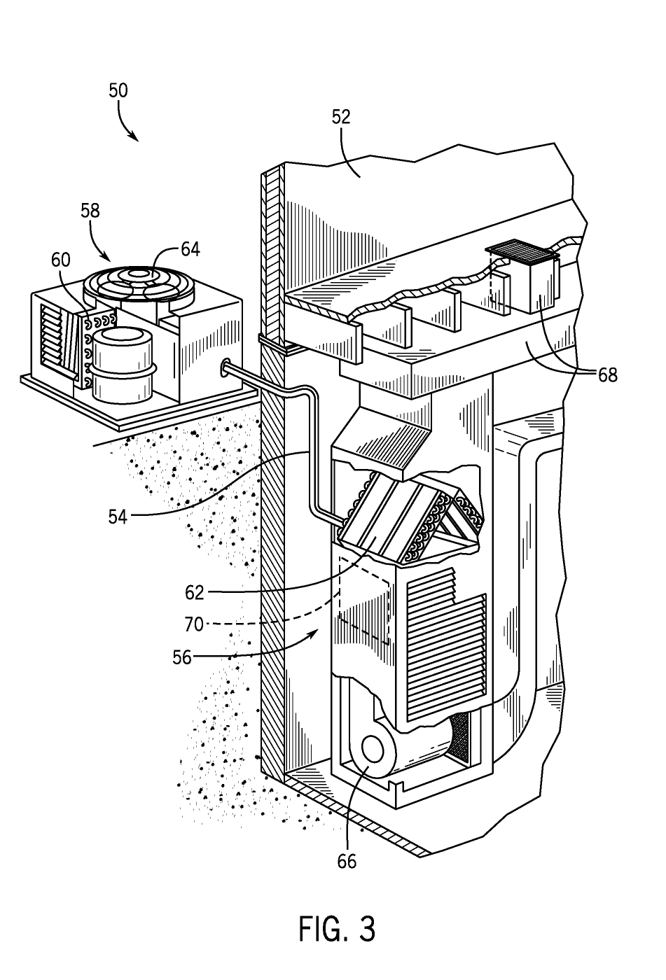

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes a HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

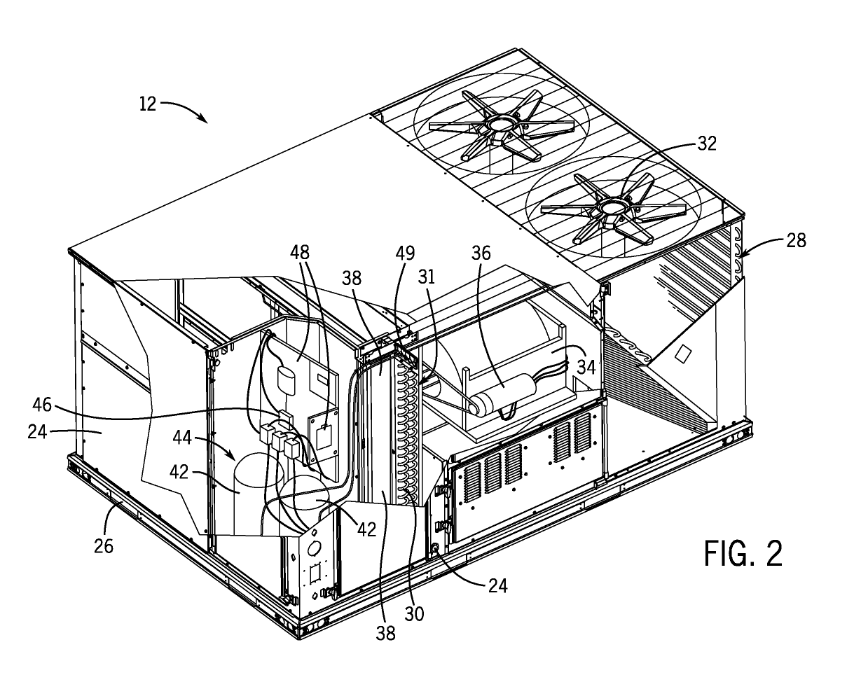

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant through the heat exchangers 28 and 30. For example, the refrigerant may be R-410A. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger that is separate from heat exchanger 62, such that air directed by the blower 66 passes over the tubes or pipes and extracts heat from the combustion products. The heated air may then be routed from the furnace system 70 to the ductwork 68 for heating the residence 52.

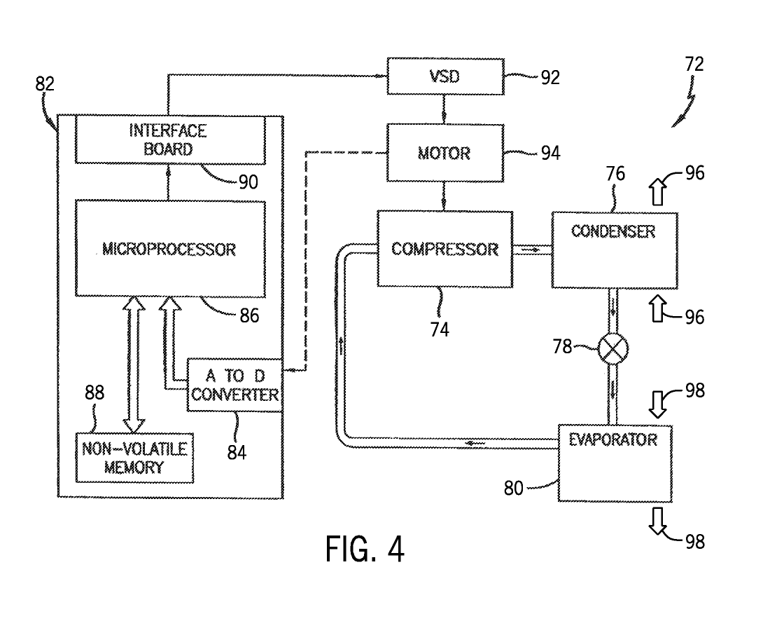

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

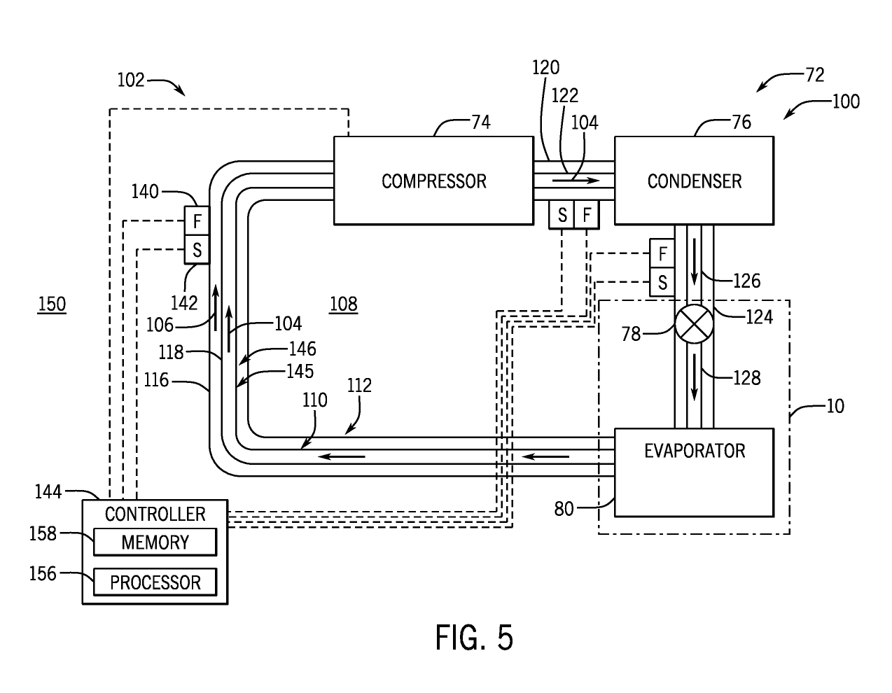

FIG. 5 is a schematic diagram of an embodiment of a HVAC system 100 having a refrigerant leak management system 102 for detecting and controlling a concentration of refrigerant that has leaked from vapor compression system 72, also referred to herein as refrigeration circuit 72. As shown, the refrigeration circuit 72 of the HVAC system 100 includes the compressor 74, the condenser 76, the expansion device 78, and the evaporator 80 discussed above. The compressor 74 moves a refrigerant 104 along conduits 110 that fluidly couple the compressor 74, the condenser 76, the expansion device 78, and the evaporator 80. The refrigerant 104 may be any desired refrigerant, such as R32, R1234ze, R1234yf, R-454A, R-454C, R-455A, R-447A, R-452B, R-454B, and the like. As will be discussed in more detail below, the refrigerant leak management system 102 may detect a flow of leaked refrigerant 106 of the refrigerant 104 from the refrigeration circuit 72, and perform suitable control actions to mitigate the leaked refrigerant 106.

Moreover, the illustrated embodiment of the HVAC system 100 conditions a building 10, such as the residence 52 discussed above, by providing conditioned air to an interior of the building 10. As shown, the expansion device 78 and the evaporator 80 are located or positioned within the building 10 and the compressor 74 and the condenser 76 are located or positioned outside of the building 10. For example, the expansion device 78 and the evaporator may be part of the indoor HVAC unit 56, while the compressor 74 and the condenser 76 may be part of the outdoor HVAC unit 58 of the residential heating and cooling system 50, as discussed above with respect to FIG. 3. As such, certain embodiments of the refrigerant leak management system 102 can advantageously draw leaked refrigerant 106 from the building 10 and into an external environment 108.

Additionally, the illustrated embodiment of the refrigerant leak management system 102 in FIG. 5 includes refrigerant conduit sleeves 112, also referred to hereafter as sleeves 112, respectively disposed around the conduits 110, such that the sleeves 112 are generally coextensive across a length of the conduits 110. For example, a first sleeve 116 is disposed around a first conduit 118 extending between the evaporator 80 and the compressor 74, and a second sleeve 120 is disposed around a second conduit 122 extending between the compressor 74 and the condenser 76. Additionally, a third sleeve 124 is disposed around both of a third conduit 126 extending between the condenser 76 and the expansion device and a fourth conduit 128 extending between the expansion device 78 and the evaporator 80. However, in other embodiments, any suitable number of sleeves 112 may be disposed around any suitable number of conduits 110. For example, in certain embodiments, each conduit 110 may be covered by respective sleeves 112, or one or more of the sleeves 112 may be designed to extend over multiple conduits 110.

The disclosed sleeves 112 may be any suitable tubular members or conduits of sufficient size for receiving the conduits 110 therein. In embodiments in which one of the sleeves 112 extends over other components such as the expansion device 78, a portion of the sleeve extending over the other component may have an increased circumferential size as compared to other portions of the sleeves 112 of the refrigerant leak management system 102. Thus, the sleeves 112 may circumferentially surround the conduits 110 to capture a leak of the refrigerant 104 therein. In particular, a gap 145 is defined between an interior surface or boundary of each sleeve and an exterior surface or boundary of the conduit. In some embodiments, this gap 145 between respective sleeves and respective conduits includes an interior volume 146 therein. Under certain conditions, refrigerant 104 leaking from the conduits 110 thus enters the gap 145 of the sleeves 112.

In some embodiments, the sleeves 112 may be formed of a strong and/or rigid material, such as plastic, metal, alloy, concrete, ceramic, or the like. Thus, the sleeves 112 may protect the conduits 110 from structural damage via puncturing, compressing, crimping, vibrations, or the like. Additionally or alternatively, in some embodiments, the sleeves 112 may be formed from or include a thermally insulated material to further reduce heat transfer between the conduits 110 and an environment around the conduits 110, as compared to thermal insulation provided by air within the gap between the sleeves 112 and the conduits 110. For example, the sleeves 112 may include insulation disposed around an outer surface of the sleeves 112, or may be entirely formed from a thermally insulated material. The insulation or the thermally insulated materials may be formed of such materials as foam, fiberglass, rubber, plastic, or the like.

Additionally, the illustrated embodiment of the refrigerant leak management system 102 employs suitable fluid moving devices, such as illustrated fans 140 that are communicatively coupled to an electronic controller 144, or other suitable control circuitry, to maintain a target sub-barometric pressure within the sleeves 112. In certain embodiments, the fans 140 are free of activation sources and/or are driven by motors that are free of activation sources, such as sparks. It is to be understood that the sub-barometric pressure may include any suitable pressure less than barometric pressure at a location having the refrigerant leak management system 102, including negative or vacuum pressures. For example, the fans 140 may maintain the sub-barometric pressure within the sleeves 112 at 99.5 percent of the barometric pressure, 99.0 percent of the barometric pressure, 98.5 percent of the barometric pressure, 98.0 percent of the barometric pressure, 95.0 percent of the barometric pressure, 90.0 percent of the barometric pressure, or lower; or at 0.995 atm, 0.990 atm, 0.985 atm, 0.980 atm, 0.950 atm, 0.900 atm, or lower. Focusing the discussion on the first sleeve 116, the fan 140 may be embedded in a surface of the first sleeve 116, or otherwise fluidly coupled to the first sleeve 116. By drawing air from the gap 145 or annular space defined between the inner surface of the first sleeve 116 and the outer surface of the first conduit 118, the fan 140 maintains the sub-barometric pressure within this gap 145 of the first sleeve 116. Then, the air passes through the fan 140 and into an external environment 150.

By transmitting control signals to the fan 140, the illustrated controller 144 operates the fan to maintain the sub-barometric pressure within the first sleeve 116. As illustrated, the fans 140 are similarly fluidly coupled to the respective gap 145 of other sleeves 112 of the refrigerant leak management system 102 to maintain a sub-barometric pressure within the other sleeves 112 as well. In some embodiments, a common or shared sub-barometric pressure is maintained in each of the sleeves 112 using a common or shared fluid moving device. However, the target sub-barometric pressure for each of the sleeves 112 may be predetermined based on relevant parameters of the HVAC system 100, such as flowrates, pressures, temperatures, outside air temperature, etc. Although described herein as employing fans 140, the refrigerant leak management system 102 may, additionally or alternatively, use other fluid moving devices, such as blowers, vacuum pumps, compressors, or other devices capable of moving any suitable fluid from one environment to another environment. Further, in certain embodiments, a pressure sensor or a flowrate sensor communicatively coupled to the controller 144 is fluidly coupled to the gap 145 of each of the sleeves 112 to transmit signals indicative of the pressure within each of the sleeves 112. In such embodiments, the controller 144 may verify the pressure within the gap 145 and adjust the pressure to be within a threshold of the target sub-barometric pressure based on sensor feedback. In certain embodiments, the refrigerant leak management system 102 may also include pressure-relief devices, such as rupture discs and/or pressure relief valves, coupled to the sleeves 112 at positions that are outside of the building 10. As such, in response to the pressure within the sleeves 112 exceeding a predetermined pressure threshold, the pressure-relief devices may open due to over pressuring and fluidly couple the gap 145 to the external environment 108.

Moreover, the embodiment of the refrigerant leak management system 102 illustrated in FIG. 5 includes concentration sensors 142 communicatively coupled to the controller 144 to detect a concentration of a refrigerant within the sleeves 112. By way of example, one or more concentration sensors 142 may be disposed on the first sleeve 116, within the first sleeve 116, or otherwise fluidly coupled to the gap 145 within the first sleeve 116 to sense a concentration of the refrigerant 104 therein. The concentration sensor 142 transmits a sensor signal indicative of a concentration of the refrigerant 104 within the gap 145 of the first sleeve 116. The concentration sensor 142 may be disposed proximate the fan 140. As used herein, concentration sensors 142 are “proximate” the fan 140 when the concentration sensors 142 are capable of measuring a concentration of the refrigerant 104 in the air or fluid passing through the fan 140. In some embodiments, the concentration sensor 142 is upstream or directly upstream of the fan 140, though in some embodiments, the concentration sensor 142 is disposed downstream of the fan 140 or in another location suitable for sensing the concentration of the refrigerant 104. When disposed proximate the fan 140, it is presently recognized that the concentration sensor 142 is exposed to a greater amount of air flow as compared to concentration sensors disposed further from the fan 140 to enhance management of the refrigerant 104. As shown, the fans 140 and the concentration sensors 142 may be disposed at an end or a proximate portion of each of the sleeves 112. For example, as shown in the present embodiment, the fans 140 and the concentration sensors 142 associated with the first sleeve 116 and the third sleeve 124 are located at proximate portions of the first sleeve 116 and the third sleeve 124 to enable the fans 140 to purge a refrigerant out of the building 10. However, any suitable number of fans 140 and concentration sensors 142 may be included on or in any quantity of the sleeves 112. For example, in certain embodiments, one fan 140 and one concentration sensor 142 may be used for the first sleeve 116 and the second sleeve 120, or one fan 140 and one concentration sensor 142 may be used for the first sleeve 116, the second sleeve 120, and the third sleeve 124.

The concentration sensors 142 may be any type of concentration sensors, including electrochemical gas detectors, catalytic bead sensors, photoionization detectors, infrared point sensors, infrared imaging sensors, semiconductor sensors, ultrasonic gas detectors, holographic gas sensors, or any other suitable concentration sensor capable of detecting a concentration of the refrigerant 104. Additionally, each of the sleeves 112 may include a different concentration sensor 142 that is preselected based on parameters of the HVAC system, such as nearby equipment, available power supply, or other considered parameters. Moreover, although discussed herein as having concentration sensors 142, the refrigerant leak management system 102 may, additionally or alternatively, include other sensors suitable for detecting a presence of the refrigerant 104 within the sleeves 112, such as temperature sensors, pressure sensors, acoustic sensors, flowrate sensors, etc.

The controller 144 receives the signals from the concentration sensors 142 indicative of the concentration of the refrigerant 104 within the gap 145 defined between the conduits 110 and the sleeves 112. Then, based on the signals, the controller 144 determines the concentration of the refrigerant 104. For example, during operation of the HVAC system 100, a leak of the refrigerant 104 may not be present. Thus, if no leak of the refrigerant 104 is present, the controller 144 may determine that the concentration of the refrigerant 104 is below a lower management limit of the concentration sensors 142. However, when refrigerant 104 leaks from a conduit 110 and is drawn across the concentration sensor 142 by the fan 140, the controller 144 receives the signals and determines a non-zero concentration of the refrigerant 104 within the sleeves 112 around the conduits 110.

Additionally, the controller 144 compares the concentration of the refrigerant 104 to a predefined concentration threshold. The predefined concentration threshold may be a user-set, technician-set, or distributor-set value that is stored within the controller 144, either before or after the controller 144 is placed into operation within the HVAC system 100. In response to determining that the concentration of the refrigerant 104 is less than or equal to the predefined concentration threshold, the controller 144 continues to operate the fans 140 to maintain the sub-barometric pressure, and continues to determine the concentration of the refrigerant 104. In some embodiments, rather than continuously measure, the controller 144 and the concentration sensors 142 may also wait a predefined time threshold before determining the concentration of the refrigerant 104 again, thus enhancing sensor life. In certain embodiments, the predefined time threshold is set as 1 minute, 5 minutes, 10 minutes, 60 minutes, or more.

In certain embodiments, in response to determining that the concentration of the refrigerant 104 is greater than the predefined concentration threshold, the controller 144 provides a control signal modifying operation of the HVAC system 100. The control signal modifies the HVAC system 100 to provide alerts and/or perform mitigating actions in response to a detected refrigerant leak. For example, the control signal may instruct the HVAC system 100 to stop operating or to stop driving the compressor 74. Suitable alerts may include notice of the concentration of the refrigerant 104 that is greater than the predefined concentration threshold. Additionally, the controller 144 may transmit the control signal to instruct a device, such as a thermostat, a user device, and/or a service technician workstation, to generate an alert indicative of the detected refrigerant leak, which includes instructions to deactivate activation sources and/or to instruct users to respond appropriately. Once informed of the detected refrigerant leak, users may perform manual control actions, such as shutting off the HVAC system 100 or repairing a conduit 110 responsible for the detected refrigerant leak.

Additionally, the control signal may automatically modify operation of the refrigerant leak management system 102 to mitigate the detected refrigerant leak. For example, the control signal may instruct the fans 140 at an increased flowrate compared to a normal flowrate of the fans 140 used to maintain the sub-barometric pressure within the sleeves 112. Thus, the fans 140 may drive more air through the gap 145 of the sleeves 112 and direct the resulting mixture of air and leaked refrigerant 106 into the external environment 150, which may be outside the building 10 associated with the HVAC system 100. In this manner, control signals provided by the controller 144 may operate the refrigerant leak management system 102 to dilute, remove, or mitigate refrigerant 104 sourced from the detected refrigerant leak until the detected refrigerant leak is resolved. Moreover, one or more of the above modifications to the refrigerant leak management system 102 and/or the HVAC system 100 may be performed simultaneously or within a time threshold to more rapidly respond to the detected refrigerant leak. Additionally, in some embodiments, the controller 144 may block the HVAC system 100 from operating or entering ON-cycle until after the concentration of the refrigerant is again within the predefined concentration threshold, or until after the detected refrigerant leak is repaired.

In some embodiments, the controller 144 may employ a feedback loop to adjust the modifications to the HVAC system 100. That is, the controller 144 may implement a dynamic response strategy that monitors the concentration of the refrigerant 104 after the refrigerant leak is detected to evaluate an effectiveness of the modifications to the HVAC system 100, and the controller 144 may further modify and/or adjust operation of the HVAC system 100 based on the determined effectiveness. For example, in certain embodiments, after determining that the concentration of the refrigerant 104 in the first sleeve 116 is above the predefined concentration threshold, the controller 144 may instruct the fan 140 of the first sleeve 116 to increase a flowrate of air through the fan 140 and the first sleeve 116. Then, the controller 144 may receive additional signals indicative of the concentration of the refrigerant 104 in the first sleeve 116 from the concentration sensor 142. Such signals may be received, for example, continuously, at regular intervals, every minute, every ten minutes, or the like. If the controller 144 determines that the concentration of the refrigerant 104 has dropped or is dropping below the predefined concentration threshold, the controller 144 may instruct the fan 140 to return to a normal operating flowrate. However, if the controller 144 determines that the concentration of the refrigerant 104 is still above the predefined concentration threshold, or determines that the concentration is still increasing after a threshold amount of time, the controller 144 may instruct the fan 140 and/or other features of the sleeve 116 to further increase the flowrate of air therethrough. The dynamic response strategy may be implemented across any range of flowrates that the fans 140 may produce. Thus, the controller 144 controls the refrigerant leak management system 102 to both detect and mitigate detected refrigerant leaks from the HVAC system 100 to block or prevent the refrigerant 104 from reaching the predefined concentration threshold.

In the embodiment illustrated in FIG. 5, the controller 144 is the HVAC controller that governs operation of the HVAC system 100. The controller 144 may include a distributed control system (DCS) or any computer-based workstation. For example, the controller 144 can be any device employing a general purpose or an application-specific processor 156, both of which may generally include memory 158 or suitable memory circuitry for storing instructions. However, in certain embodiments, the controller 144 may be a separate controller for controlling the refrigerant leak management system 102.

The processor 156 illustrated in FIG. 5 may include one or more processing devices, and the memory 158 may include one or more tangible, non-transitory, machine-readable media collectively storing instructions executable by the processor 156 to control the refrigerant leak management system 102 and/or the HVAC system 100. The processor 156 of the controller 144 may be used to operate the refrigerant leak management system 102 and the HVAC system 100 and perform the actions disclosed herein. More specifically, the controller 144 may receive input signals from various components of the HVAC system 100 and outputs control signals to control and communicate with various components in the HVAC system 100. The processor 156 of the controller 144 may control the flowrates, motor speeds, valve positions, and emissions, among other parameters, of the HVAC system 100.

Although the controller 144 has been described as having the processor 156 and the memory 158, it should be noted that the controller 144 may include or be communicatively coupled to a number of other computer system components to enable the controller 144 to control the operations of the HVAC system 100 and the related components. For example, the controller 144 may include a communication component that enables the controller 144 to communicate with other computing systems. The controller 144 may also include an input/output component that enables the controller 144 to interface with users via a graphical user interface or the like. In addition, the communication between the controller 144 and other components of HVAC system 100 may be via a wireless connection, such as through Bluetooth® Low Energy, ZigBee®, WiFi®, or may be a or wired connection, such as through Ethernet. In some embodiments, the controller 144 may include a laptop, a smartphone, a tablet, a personal computer, a human-machine interface, or the like. In some embodiments, the embodiments disclosed herein may be at least partially embodied using hardware implementations. For example, logic elements of the controller 144 may include a field-programmable gate array (FPGA), or other specific circuitry.

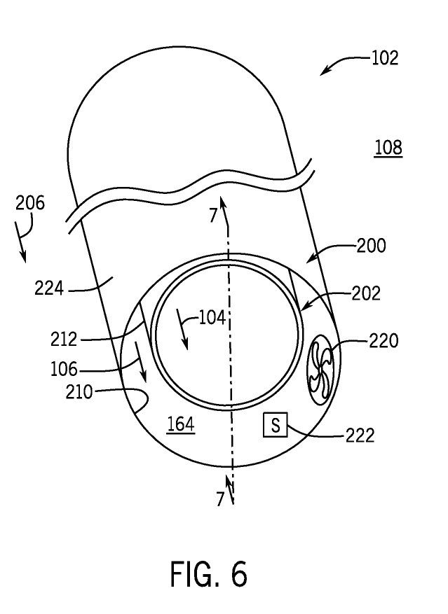

FIG. 6 is a front perspective view of an embodiment of a sleeve 200 of the refrigerant leak management system 102 disposed circumferentially around a conduit 202. The conduit 202 may be any of the conduits 110 of FIG. 5, and the sleeve 200 may be any of the sleeves 112 of FIG. 5. As shown, the gap 145 of the sleeve 200 is defined between an inner surface 210 of the sleeve 200 and an outer surface 212 of the conduit 202. Additionally, the refrigerant 104 may flow through the gap 145 of the conduit 202 as the refrigerant 104 traverses the refrigeration circuit of the HVAC system 100.

For the illustrated embodiment, a fan 220 is embedded within the sleeve 200, such that the fan 220 maintains the sub-barometric pressure within the gap 145. For example, the fan 220 extends through or traverses the sleeve 200 to fluidly couple the gap 145 of the sleeve and the external environment 108. Moreover, a concentration sensor 222 is embedded within or disposed within and extending through a wall of the sleeve 200 to transmit signals to the controller 144 of FIG. 5 indicative of the concentration of the refrigerant 104 within the gap 145. In other embodiments, the fan 220 and/or the concentration sensor 222 may be located at alternative locations within the refrigerant leak management system 102 and are fluidly coupled to the gap 145 of the sleeve 200. For example, concentration sensors 222 may be disposed outside of the sleeve 200 and have a sensing element that extends into the gap 145 within the sleeve 200. Moreover, the fan 220 may be fluidly coupled to the sleeve 200 by a port or an attachment extension that is distally coupled to an outer surface 224 of the sleeve 200. In this manner, the fan 220 may be located at various positions relative to the sleeve 200 to enable easy access for maintenance and/or assembly of the refrigerant leak management system 102.

In certain situations, as discussed above, the refrigerant 104 may leak from the conduit 202 as leaked refrigerant 106 that enters the gap 145 within the sleeve 200. As discussed, the sub-barometric pressure within the gap 145 encourages the leaked refrigerant 106 to flow an axial direction 206 within the sleeve 200, proximate the concentration sensor 222, through the fan 220, and into the external environment 108. Thus, the refrigerant leak management system 102 detects and mitigates the leaked refrigerant 106 concentration before a buildup to the predefined concentration threshold may occur.

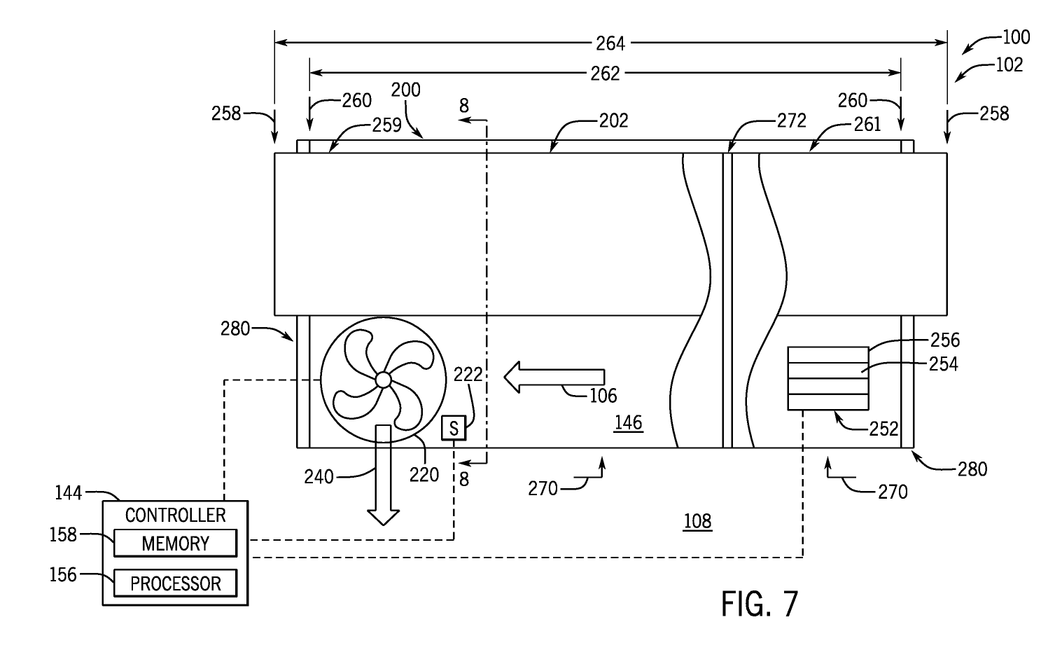

Looking along the 7-7 line of FIG. 6, FIG. 7 is a side cross-sectional view of an embodiment of the sleeve 200. In certain situations, after the HVAC system 100 is worn or experiences damage, refrigerant may leak from the conduit 202 and become the leaked refrigerant 106 within the gap 145 defined between the sleeve 200 and the conduit 202. To stop the leaked refrigerant 106 from concentrating within the gap 145 and reaching the predefined concentration threshold, the refrigerant leak management system 102 includes the controller 144, the fan 220, and the concentration sensor 222 discussed above. As mentioned, the fan 220 maintains the sub-barometric pressure within the gap 145. Additionally, the controller 144 determines the concentration of the leaked refrigerant 106 based on signals received from the concentration sensor 222. In response to determining that the concentration of the leaked refrigerant 106 exceeds the predefined concentration threshold, the controller then provides control signals to various components of the refrigerant leak management system 102 and/or the HVAC system 100 to provide alerts indicative of the detected refrigerant leak and to mitigate the detected refrigerant leak.

To also fluidly couple the gap 145 to the external environment 108, the embodiment of the refrigerant leak management system 102 illustrated in FIG. 7 includes an air intake regulation device 252. The air intake regulation device 252 may be one or more of any suitable openings, adjustable louvers, adjustable baffles, moveable baffles, set of moveable baffles, dampers, or any other suitable air or fluid intake regulation device disposed within the sleeve 200. In certain embodiments, the air intake regulation device 252 may be particularly disposed in an opposite end of the sleeve 200 relative to the fan 220 and the concentration sensor 222, and/or preferentially located outside of the building 10 conditioned by the HVAC system 100, to enable fresh air to enter the sleeve 200. The illustrated air intake regulation device 252 includes a set of slats 254 extending across an opening 256 in the sleeve 200.

Upon instruction from the controller 144, the air intake regulation device 252 may adjust a position of the slats 254 to vary the size of an intake opening between the external environment 108 and the gap 145. In some embodiments, the slats 254 are adjustable between completely closed, partially opened, and/or completely open positions. When in a completely or partially open state, air removed from the gap 145 by the fan 220 is replaced by air drawn in through the air intake regulation device 252. For example, when the slats 254 are in a fully open position, the intake opening between the external environment 108 and the gap has a maximum size, such that more air is replaced through the opening than when the slats 254 were in a partially open position or a fully closed position. Moreover, in certain embodiments, even when the air intake regulation device 252 is in the fully closed position, the air intake regulation device 252 the sleeve 200, and/or joints of the sleeve 200 may enable a limited amount of air to enter the sleeve 200, such that the fan 220 is capable of maintaining the sub-barometric pressure in such embodiments. Although discussed as the air intake regulation device 252, any suitable component for fluidly coupling the gap 145 to the external environment 108 may be provided in place of the air intake regulation device 252, including a cutout from the sleeve 200, an opening, a port, static louvers, jalousies, a mechanically controlled hatch, a valve, etc. Additionally, the air intake regulation device 252 may be fluidly coupled to the sleeve 200 by any suitable means instead of being embedded within the sleeve 200, such as by an adjoining sleeve fluidly coupled to the sleeve 200.

For the embodiment illustrated in FIG. 7, the controller 144 is capable of adjusting both a speed or rotational rate of the fan 220 and the position of the slats 254 of the air intake regulation device 252 to maintain a target sub-barometric pressure within the sleeve 200. In this manner, the controller 144 may manipulate a position of the air intake regulation device 252 as part of the dynamic response strategy for mitigating the leaked refrigerant 106. For example, in certain embodiments, after determining that the refrigerant concentration exceeds the predetermined concentration threshold, the controller 144 instructs the air intake regulation device 252 to move the slats 254 to a more open position to enable more air to enter into the gap 145 and/or increase the speed of the fan 220 to purge the leaked refrigerant 106 from the sleeve 200. Then, to enable feedback control, when the controller 144 determines that the refrigerant concentration is increasing or still exceeds the predetermined concentration threshold after a predetermined amount of time has passed, the controller 144 instructs the air intake regulation device 252 to move the slats 254 to an even more open position to provide more air into the gap 145 and/or instructs the fan 220 to further increase the speed of the fan 220. Thus, the fan 220 may blow the leaked refrigerant 106 out of the gap 145 and into the external environment 108 in a dynamically responsive manner, in certain embodiments.

Additionally, in various embodiments, the sleeve 200 may be installed around the conduit 202 by one of multiple processes. As discussed, the conduit 202 is fluidly coupled to other components of the refrigeration system, and thus, is rigidly attached at both ends 258 of the conduit 202 to the other components. In some embodiments, the sleeve 200 may be loosely disposed around the conduit 202 before the ends 258 of the conduit 202 are coupled to the other components. Additionally, in some embodiments, the sleeve 200 may be separable into multiple longitudinal sections 270 which snap or fasten together at corresponding ends of the longitudinal sections to form the continuous sleeve 200, and the longitudinal sections 270 of the sleeve 200 are snapped together around the conduit 202 before or after the ends 258 of the conduit 202 are coupled to the other components. In certain embodiments, the longitudinal sections 270 are coupled together at a joint 272. The joint 272 may be formed from any suitable coupling means, including corresponding threaded portions disposed on the longitudinal sections 270, an outer cuff disposed over end portions of the longitudinal sections 270 to couple the longitudinal sections 270 together, etc. Additionally, the sleeve 200 may be secured around the conduit 202 via any suitable mating/attachment features, such as raised alignment features coupled to or integrally formed with the conduit 202, and corresponding recessed alignment features disposed within the sleeve 200.

As discussed herein, a proximate portion 259 of the sleeve 200 includes the fan 220 and the concentration sensor 222, while a distal portion 261 of the sleeve 200 includes the air intake regulation device 252. Additionally, ends 260 of the sleeve 200 may remain unattached from the other components of the refrigeration circuit and the conduit 202 to enable the conduit 202 to thermally expand relative to the sleeve 200 based on operation of the HVAC system 100. For example, the illustrated conduit 202 has a conduit length 264 that is longer than a sleeve length 262 of the sleeve 200. The difference between the conduit length 264 and the sleeve length 262 may be preselected based on thermal expansion properties of the conduit 202 and the sleeve 200, and based on properties of the refrigerant within the conduit 202. For example, if the conduit 202 is capable of contracting in size during operation of the HVAC system 100, such as due to cold and/or condensed refrigerant flowing through the conduit 202, the difference between the conduit length 264 and the sleeve length 262 may be designed such that contraction of the conduit 202 does not affect placement of the sleeve 200. Moreover, the ends 260 of the sleeve 200 may be sealed by any suitable means, including sealing members 280 such as annular sealing members, gaskets, caps, epoxy deposits, or the like.

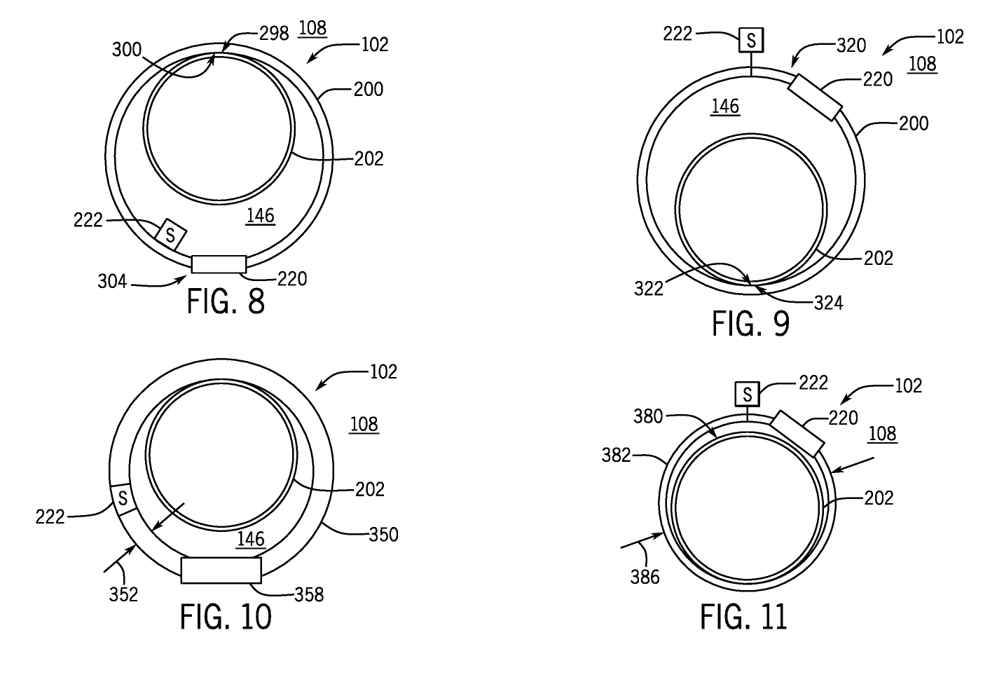

FIGS. 8-11 show cross-sectional views of various embodiments of the sleeve 200 that include multiple features that enable the refrigerant leak management system 102 to be adapted to a specific HVAC system 100. Each of FIGS. 8-11 is an embodiment of the sleeve 200 viewed along the 8-8 line of FIG. 7. For example, FIG. 8 is a cross-sectional view of an embodiment of the sleeve 200 disposed around the conduit 202. As shown, an upper outer portion 298 of the conduit 202 is in contact with an upper inner portion 300 of the sleeve 200. The sleeve 200 may be disposed on top of the conduit 202 with or without alignment features or fasteners. Thus, a large portion of the gap 145 is defined beneath the conduit 202. Moreover, the fan 220 is shown as embedded within a bottom portion 304 of the sleeve 200 to enable the fan 220 to direct air from within the gap 145 to the external environment 108. Additionally, the concentration sensor 222 is disposed proximate the fan 220 to enable the concentration sensor 222 to be exposed to a greater amount of air that is drawn out of the sleeve 200 by the fan, thus increasing sensor performance.

In case of a refrigerant leak, the refrigerant is expected to be denser than the ambient air within the sleeve 200, and sink to the bottom portion 304 of the sleeve 200. As such, placing the fan 220 in the bottom portion 304 of the sleeve 200 may enable the fan 220 to more rapidly purge the leaked refrigerant 106 to the external environment 108. However, because the fan 220 maintains a sub-barometric pressure within the sleeve 200, the fan 220 may be fluidly coupled to the gap 145 within the sleeve 200 from any position. That is, the fan 220 may be powerful enough to remove the leaked refrigerant 106 from the sleeve 200 from any suitable, fluidly coupled location.

Indeed, for the embodiment of the sleeve 200 illustrated in FIG. 9, the fan 220 is embedded in an upper portion 320 of the sleeve 200, such that the large portion of the gap 145 is defined above the conduit 202. The fan 220 therefore may draw leaked refrigerant 106 out through the fan 220 and into the external environment 108. Indeed, the fan 220 is generally designed to be powerful enough to maintain the sub-barometric pressure to facilitate refrigerant leak detection via the concentration sensor 222, and to purge and replace air within the gap 145 to address the leak. As seen in the present embodiment of the refrigerant leak management system 102, the concentration sensor 222 is disposed proximate the fan 220 embedded in the upper portion 320 of the sleeve 200. Indeed, the concentration sensor 222 may be fluidly coupled to the gap 145 of the sleeve 200 by any suitable means, such as by including a sensing tip disposed through the sleeve 200.

As shown, a lower inner portion 322 of the sleeve 200 may be in contact with a lower outer portion 324 of the conduit 202. In such embodiments, the lower inner portion 322 of the sleeve 200 may be attached to the lower outer portion 324 of the conduit 202 by any suitable attachment means, such as via fasteners, adhesive, etc. In some embodiments, the distal ends of the sleeve 200 and the distal ends of the conduit 202 may be attached to the other components of the HVAC system 100, such that attachment between the sleeve 200 and the conduit 202 is not necessary to maintain the lower inner portion 322 of the sleeve 200 and the lower outer portion 324 of the conduit 202 in contact.

As previously mentioned, the refrigerant leak management system 102 may also serve as insulation and/or physical protection for the conduit 202. For example, as shown in FIG. 10, a thick sleeve 350 is disposed around the conduit 202 that enables enhanced thermal insulation and physical protection. The illustrated thick sleeve 350 has a greater sleeve width 352 as compared to other embodiments of sleeves. In some embodiments, the thick sleeve 350 is formed wholly, primarily, or partially with insulation or materials having a low thermal conductivity. Thus, on hot days, the more insulating thick sleeve 350 may maintain the gap 145 at a lower temperature than a temperature of the external environment. Similarly, on cold days, the more insulating thick sleeve 350 may maintain the gap 145 at a higher temperature than the temperature of the external environment 108. In this manner, the refrigerant leak management system 102 may improve an operational efficiency of the HVAC system 100.

Moreover, in some embodiments, the HVAC system 100 may be retrofitted with the refrigerant leak management system 102. For example, the thick sleeve 350 may be installed around an existing conduit 202 of the HVAC system 100, and then a fan 358 and a concentration sensor 222 may be embedded or otherwise fluidly coupled to a first end of the thick sleeve 350, while the air intake regulation device 252 or another suitable air inlet may be disposed at a second end of the thick sleeve 350. Additionally, the thick sleeve 350 may protect the conduit 202 from damage by impact, punctures, vibrations, etc. However, an outer layer of structural supporting material, such as metal or plastic, may also be used to increase a damage resistance of the thick sleeve 350.

Looking now to FIG. 11, an embodiment of the sleeve 200 having a compact gap 380 is shown. The compact gap 380 may be defined between a compact sleeve 382 and the conduit 202. Indeed, relative sizing of the compact sleeve 382 and the conduit 202 may be determined based on a desired size of the compact gap 380 and/or based on a desired diameter of the refrigerant leak management system 102. For example, by having the compact gap 380, the fan 220 may operate at a lower speed and at a reduced energy expenditure, or purge the compact sleeve 383 faster when the fan 220 is operated at similar speeds, yet still maintain a similar sub-barometric pressure as compared to a comparable fan that services a larger gap. Additionally, the compact gap 380 may enable the concentration sensor 222 to inspect a greater percentage of the fluid within the compact sleeve 382, thus further increasing sensor performance compared to a comparable sensor that inspects a larger gap. Moreover, the refrigerant leak management system 102 having the compact sleeve 382 has a compact diameter 386, thus decreasing a physical size of the refrigerant leak management system 102 and enabling easier installation of the refrigerant leak management system 102 in tight clearance areas within the HVAC system 100 as compared to refrigerant leak management systems having larger sleeves.

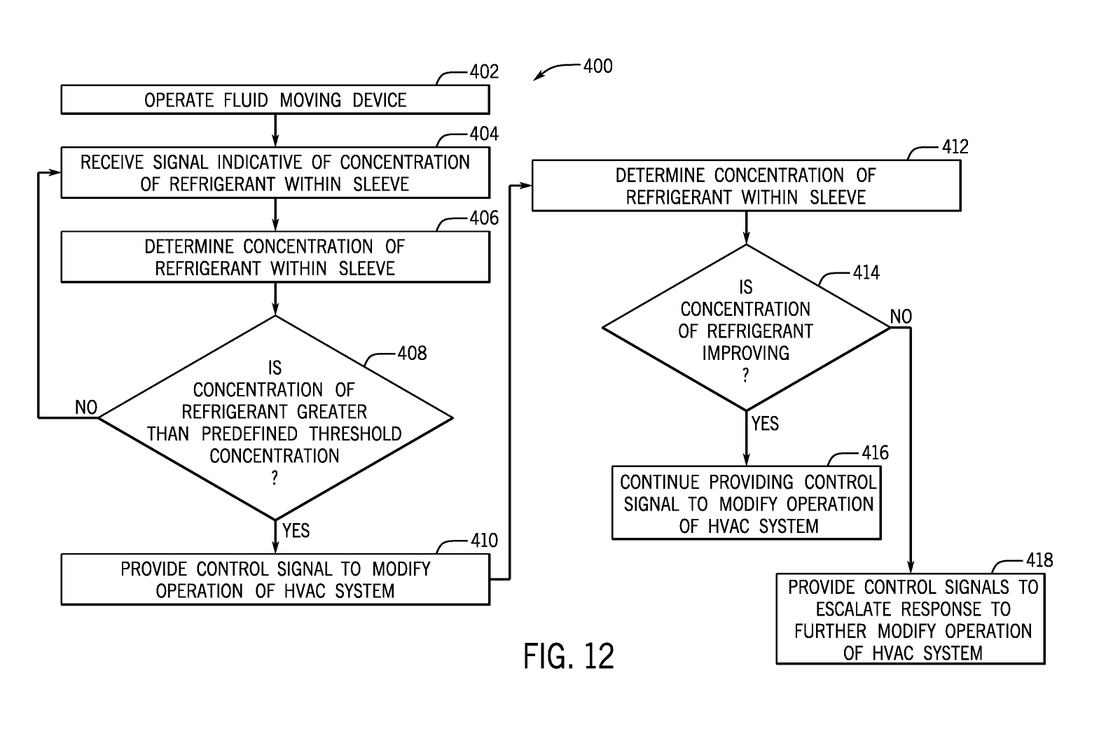

FIG. 12 is a flow diagram illustrating an embodiment of a process 400 of operating the refrigerant leak management system 102 of FIG. 5. It is to be understood that the steps discussed herein are merely exemplary, and certain steps may be omitted or performed in a different order that the order discussed herein. In some embodiments, the process 400 may be performed by the processor 156 of the controller 144, which may be a HVAC controller or a separate controller that may be communicatively coupled to the HVAC controller. Additionally, although the process 400 is discussed with reference to the first sleeve 116 of the refrigerant leak management system 102, it is to be understood that the present techniques may be extended to operate any sleeve or any combination of sleeves of the refrigerant leak management system 102 of the HVAC system 100.

To begin the illustrated process 400, the controller 144 provides a control signal to activate a fluid moving device, such as the fan 140, fluidly coupled to the gap 145 of the first sleeve 116, as indicated in block 402. For example, the controller 144 may instruct the fan 140 to operate at a predetermined speed or rotational rate to move air out of the gap 145 of first sleeve 116 disposed around the first conduit 118. By moving the air out of the first sleeve 116, the fan 140 maintains the sub-barometric pressure within the gap 145 of the sleeve. Moreover, in certain embodiments, the refrigerant leak management system 102 includes a pressure or flowrate sensor that measures the pressure within the gap 145 of the first sleeve 116, so that the controller 144 can verify and adjust the pressure within the gap 145 to the target sub-barometric pressure.

As indicated in block 404, the controller 144 receives a signal indicative of a concentration of leaked refrigerant 106 within the gap 145 of the first sleeve 116. The concentration sensor 142 fluidly coupled to the gap 145 of the first sleeve 116 may transmit the signal indicative of the concentration of the refrigerant 104 to the controller 144. Indeed, the concentration sensor 142 may transmit the signal continuously, at regular intervals, or after detecting a change in the concentration of the refrigerant 104 within the gap 145 of the first sleeve 116. Following the process 400, the controller 144 also determines the concentration of leaked refrigerant 106 within the gap 145 of the first sleeve 116, as indicated in block 406. For example, the controller 144 may determine the concentration of leaked refrigerant 106 within the gap 145 of the first sleeve 116 based on the signal transmitted from the concentration sensor 142.

The illustrated process 400 further includes the controller 144 determining whether the concentration of leaked refrigerant 106 within the gap 145 is greater than the predefined concentration threshold, as indicated in block 408. For example, the predefined concentration threshold may be a parameter stored within the memory 158 of the controller 144, as discussed above. In response to determining that the concentration of the refrigerant 104 is less than the predefined concentration threshold, the controller 144 may return to block 404 to continue receiving the signal indicative of the concentration of the refrigerant.

In response to determining that the concentration of leaked refrigerant 106 within the gap 145 is greater than the predefined concentration threshold, the controller 144 provides a control signal to modify operation of the HVAC system 100, as indicated in block 410. For example, the control signal from the controller 144 may cause the components of the HVAC system 100 to perform any suitable control actions, such as transmitting an alert indicative of the concentration of leaked refrigerant 106 to a user or to a service technician, ceasing operation of the HVAC system 100, and/or increasing a speed of the fan 140. In general, a concentration of leaked refrigerant 106 that exceeds the predefined concentration threshold is indicative of a leak of the refrigerant 104 from the refrigeration circuit 72. Thus, the control signal from the controller 144 instigates control actions which inform users or service technicians of the refrigerant leak and/or control actions that address the leaked refrigerant 106.

To perform feedback control of the refrigerant leak management system 102, the controller 144 determines the concentration of leaked refrigerant 106 in the gap 145 again, as indicated in block 412. In certain embodiments, the controller 144 determines the concentration of leaked refrigerant 106 in the gap 145 again after a threshold amount of time has passed, after receiving another signal from the concentration sensor 142, etc. Then, the controller 144 determines whether the concentration of the refrigerant 104 is improving, as indicated in block 414. For example, the concentration of the refrigerant 104 may be improving when the concentration of the refrigerant 104 is decreasing from the initial detected concentration, decreasing below the predefined concentration threshold, and/or has a rate of change greater than a rate of change threshold.

In response to determining that the concentration of the refrigerant is improving, the controller 144 continues to provide control signals to modify operations of the HVAC system 100, such as instructing the supply fan to purge the first sleeve 116, as indicated in block 416. In response to determining that the concentration of the refrigerant is not improving, the controller 144 provides control signals to escalate the response to further modify operation of the HVAC system 100, as seen in block 418. For example, the escalating response may include increasing the flowrate through the first sleeve 116 by instructing the fan 140 to increase a speed thereof or instructing an air intake regulation device to enable more air to enter the first sleeve, thus increasing a rate at which the leaked refrigerant is purged from the first sleeve 116. Accordingly, as discussed above, the control signals from the controller 144 are capable of escalating control actions to detect and mitigate leaks of the refrigerant 104 of varying severities.

The present disclosure is directed to a refrigerant leak management system for detecting and mitigating refrigerant leaks. The refrigerant leak management system includes at least one sleeve disposed around one or more refrigerant conduits that fluidly couple components of a HVAC system. The refrigerant leak management system may include thermally insulating and/or structurally sound materials to enhance the efficiency, strength, and/or operational lifetime of the HVAC system. The refrigerant leak management system also includes a fan fluidly coupled to a gap defined between a respective sleeve and a respective conduit, and a concentration sensor that transmits signals indicative of the concentration of the refrigerant within the gap to a controller. The controller monitors the concentration of the refrigerant, and in response to determining that the concentration exceeds a predetermined concentration threshold, the controller provides a control signal to modify operation of the HVAC system. For example, the control signal may cause a device to transmit an alert indicative of the concentration of the refrigerant, stop operation of the HVAC system, and/or cause the fan and/or louvers to increase a flowrate of air therethrough. In this manner, the refrigerant leak management system may improve operation of the HVAC system while enabling the detection and mitigation of refrigerant leaks substantially before the refrigerant may reach the predefined concentration threshold.

While only certain features and embodiments of the present disclosure have been illustrated and described, many modifications and changes may occur to those skilled in the art, such as variations in sizes, dimensions, structures, shapes and proportions of the various elements, values of parameters including temperatures, pressures, etc., mounting arrangements, use of materials, orientations, etc., without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the embodiments, all features of an actual implementation may not have been described, such as those unrelated to the presently contemplated best mode of carrying out the disclosure, or those unrelated to enabling the claimed features. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A refrigerant leak management system for a heating, ventilation, and air conditioning (HVAC) system, comprising:
a sleeve member having an inner surface, the sleeve member configured to be disposed over an outer surface of a refrigerant conduit of the HVAC system such that a gap is defined between the inner surface of the sleeve member and the outer surface of the refrigerant conduit;
a fluid moving device configured to fluidly couple to the gap and configured to maintain a sub-barometric pressure within the gap; and
a sensor fluidly coupled to the gap and configured to detect a concentration of a leaked refrigerant in the gap.

2. The refrigerant leak management system of claim 1, wherein the sleeve member is configured to be nested over the refrigerant conduit.

3. The refrigerant leak management system of claim 2, wherein the sleeve member is configured to be disposed circumferentially around the refrigerant conduit.

4. The refrigerant leak management system of claim 2, wherein the refrigeration conduit and the sleeve member are substantially coaxial.

5. The refrigerant leak management system of claim 1, wherein the fluid moving device is configured to maintain the sub-barometric pressure within the gap by moving a fluid from the gap to an exterior of the sleeve member.

6. The refrigerant leak management system of claim 1, wherein the fluid moving device is configured to drive a fluid from a location within the gap proximate the sensor.

7. The refrigerant leak management system of claim 1, wherein the fluid moving device comprises a fan, a blower, a vacuum pump, or a compressor.

8. The refrigerant leak management system of claim 1, wherein the fluid moving device is installed within the sleeve member and extends between the gap and an exterior of the sleeve member.

9. The refrigerant leak management system of claim 1, wherein the fluid moving device is disposed outside of the sleeve member.

10. The refrigerant leak management system of claim 1, wherein the sensor comprises a main body disposed outside of the sleeve member.

11. The refrigerant leak management system of claim 1, comprising a controller communicatively coupled to the sensor and the fluid moving device, wherein the controller is configured to:
receive a signal from the sensor indicative of the concentration of the leaked refrigerant in the gap;
determine whether the concentration is greater than a predefined concentration threshold; and
provide a control signal in response to determining that the concentration of the leaked refrigerant is greater than the predefined concentration threshold.

12. The refrigerant leak management system of claim 11, wherein the HVAC system is configured to modify its operation in response to the control signal.

13. The refrigerant leak management system of claim 12, wherein the controller is configured to modify the operation of the HVAC system by transmitting an alert indicative of the concentration of the leaked refrigerant.

14. The refrigerant leak management system of claim 12, wherein the controller is configured to modify the operation of the HVAC system by ceasing operation of the HVAC system.

15. The refrigerant leak management system of claim 12, wherein the HVAC system is configured to increase a flowrate through the gap in response to the control signal.

16. The refrigerant leak management system of claim 12, wherein a distal portion of the sleeve member comprises an opening configured to provide a fluid to the gap, wherein the refrigerant leak management system comprises a set of moveable baffles associated with the opening of the distal portion of the sleeve member, and wherein the controller is configured to adjust a position of the set of moveable baffles to modify a flowrate of the fluid provided to the gap.

17. The refrigerant leak management system of claim 16, wherein the operation of the HVAC system is configured to adjust the position of the set of moveable baffles to modify the flowrate of the fluid provided to the gap in response to the control signal.

18. The refrigerant leak management system of claim 16, wherein the fluid moving device is fluidly coupled to the sleeve member at an end of the sleeve member opposite the distal portion of the sleeve member.

19. The refrigerant leak management system of claim 18, wherein the HVAC system is configured to condition a building, and wherein the end of the sleeve member is disposed outside of the building, such that the fluid moving device is configured to move the fluid from the gap to an exterior of the building.

20. The refrigerant leak management system of claim 1, comprising an additional sleeve member, wherein an additional gap is defined between an additional inner surface of the additional sleeve member and an outer surface of an additional refrigerant conduit, and wherein the gap and the additional gap are in fluid communication with each other.

21. The refrigerant leak management system of claim 20, wherein the refrigerant conduit and the additional refrigerant conduit are joined.

22. The refrigerant leak management system of claim 1, comprising the refrigerant conduit of the HVAC system, wherein the HVAC system comprises a refrigerant circuit comprising an evaporator and a compressor, and wherein the refrigerant conduit is a part of the refrigerant circuit.

23. A heating, ventilation, and air conditioning (HVAC) system, comprising:
a refrigerant conduit of a refrigeration circuit having an outer surface;
a sleeve member configured to be disposed circumferentially around a length of the refrigerant conduit, wherein a gap is defined between an inner surface of the sleeve member and the outer surface of the refrigerant conduit;
a fluid moving device fluidly coupled to the gap and configured to maintain a sub-barometric pressure within the gap; and
a sensor fluidly coupled to the gap and configured to detect a concentration of a leaked refrigerant in the gap.

24. The HVAC system of claim 23, comprising a controller communicatively coupled to the sensor and the fluid moving device, wherein the controller is configured to:
receive a signal from the sensor indicative of the concentration of the leaked refrigerant in the gap;
determine whether the concentration is greater than a predefined concentration threshold; and
provide a control signal modifying operation of the HVAC system in response to determining that the concentration is greater than the predefined concentration threshold.

25. The HVAC system of claim 24, wherein the controller is configured to receive a signal indicative of a pressure within the gap, determine the pressure within the gap, and in response to determining that the pressure within the gap is above the sub-barometric pressure, increase a speed of the fluid moving device to modify the pressure within the gap to be the sub-barometric pressure.

26. The HVAC system of claim 24, wherein modifying operation of the HVAC system comprises transmitting an alert indicative of the concentration of the leaked refrigerant.

27. The HVAC system of claim 24, wherein modifying operation of the HVAC system comprises ceasing operation of the HVAC system.

28. The HVAC system of claim 24, wherein modifying operation of the HVAC system comprises increasing a flowrate through the fluid moving device by increasing a speed of the fluid moving device.

29. The HVAC system of claim 24, wherein modifying operation of the HVAC system comprises increasing a flowrate through the fluid moving device by adjusting an amount of fluid provided to the gap.

30. A method of operating a refrigerant leak management system of a heating, ventilation, and air conditioning (HVAC) system of a building, the method comprising:
operating a fluid moving device to maintain a sub-barometric pressure within a gap defined between an inner surface of a sleeve member and an outer surface of a refrigerant conduit of the HVAC system, wherein the sleeve member circumferentially surrounds a length of the refrigerant conduit;
determining a concentration of a leaked refrigerant within the gap based on input from a sensor; and
modifying operation of the HVAC system in response to determining that the concentration of the leaked refrigerant is greater than a predefined concentration threshold.

31. The method of claim 30, comprising measuring a pressure within the sleeve member, and providing a control signal to the fluid moving device to instruct the fluid moving device to modify an operating speed of the fluid moving device to adjust the sub-barometric pressure within the sleeve member.

32. The method of claim 30, wherein operating the fluid moving device comprises providing a fluid at a first flowrate through the sleeve member, wherein modifying operation of the HVAC system comprises modifying operation of the fluid moving device to provide the fluid at a second flowrate through the sleeve member, and wherein the second flowrate is greater than the first flowrate.

33. The method of claim 32, wherein modifying operation of the HVAC system comprises modifying operation of a fluid intake regulation device to provide the fluid at the first flowrate and the second flowrate of fluid through the sleeve member, and wherein the fluid intake regulation device disposed in a distal portion of the sleeve member and is fluidly coupled to an environment that is external to the sleeve member.
